(19) United States
(12) Patent Application Publication
(10) Pub. No.: US 2026/0267195 A1
(43) Pub. Date: Sep. 10, 2026

(54) MZM based dense interconnects

(71) Applicant: Marvell Asia Pte Ltd, Singapore (SG)

(72) Inventors: Tonmoy Shankar Mukherjee, Camarillo, CA (US); Masaki Kato, Palo Alto, CA (US); Matthew Traverso, Saratoga, CA (US)

(21) Appl. No.: 19/557,196

(22) Filed: Mar. 5, 2026

Related U.S. Application Data
(60) Provisional application No. 63/768,158, filed on Mar. 6, 2025.

(51) Int. Cl. G02F 1/21; G02F 1/225

(52) U.S. Cl. CPC G02F 1/212; G02F 1/225

(57) ABSTRACT

A Mach-Zehnder modulator (MZM) includes a waveguide arrangement, an electrode structure, an input, and an output. The waveguide arrangement has a first waveguide arm and a second waveguide arm arranged in parallel. The first and second waveguide arms have a length of less than 2 millimeters. The electrode structure is associated with the waveguide arrangement and has a differential impedance of at least 100 ohms. The input splits an input optical signal into a first optical signal portion propagating through the first waveguide arm and a second optical signal portion propagating through the second waveguide arm. The output combines the first optical signal portion from the first waveguide arm and the second optical signal portion from the second waveguide arm into an output optical signal.

### CROSS-REFERENCE TO RELATED APPLICATIONS

This application claims the benefit of U.S. Provisional Application No. 63/768,158, filed Mar. 6, 2025, the disclosure of which is incorporated herein by reference in its entirety.

### TECHNICAL FIELD

The present disclosure relates generally to optical communication systems, and more particularly but not exclusively to optical modulators for dense optical interconnects.

### BACKGROUND

Optical communication systems utilize various modulator technologies to encode data onto optical signals. Micro-Ring Modulators (MRMs) and Mach-Zehnder Modulators (MZMs) are two common types of optical modulators used in optical interconnect applications.

MRMs offer a compact footprint and inherent wavelength selectivity, enabling self-multiplexing and demultiplexing functionality. However, MRMs require complex control to maintain stable operation due to sensitivity to temperature variations and central frequency drift. MRMs also exhibit pattern dependency, wherein the data pattern affects the thermal characteristics of the device, causing bias point drift.

MZMs offer stable operation and well-understood control characteristics, but have larger footprint.

Dense optical interconnect systems often employ wavelength division multiplexing to increase data throughput. Such systems require modulators, multiplexers, demultiplexers, and associated electronic circuitry to be integrated in a compact form factor.

### SUMMARY

There is provided in accordance with an embodiment of the present disclosure, a Mach-Zehnder modulator (MZM) comprising a waveguide arrangement comprising a first waveguide arm and a second waveguide arm arranged in parallel, the first and second waveguide arms having a length of less than 2 millimeters, an electrode structure associated with the waveguide arrangement, the electrode structure having a differential impedance of at least 100 ohms, an input configured to split an input optical signal into a first optical signal portion propagating through the first waveguide arm and a second optical signal portion propagating through the second waveguide arm, and an output configured to combine the first optical signal portion from the first waveguide arm and the second optical signal portion from the second waveguide arm into an output optical signal.

Further in accordance with an embodiment of the present disclosure, the MZM is configured to operate at an off-quadrature bias point.

Still further in accordance with an embodiment of the present disclosure, the MZM is configured to modulate the input optical signal using a non-return-to-zero (NRZ) modulation format.

Additionally in accordance with an embodiment of the present disclosure, the first and second waveguide arms have a length between 1.0 millimeters and 1.2 millimeters.

Moreover in accordance with an embodiment of the present disclosure, the electrode structure has a differential impedance between 150 ohms and 200 ohms.

Further in accordance with an embodiment of the present disclosure, the electrode structure comprises a meandering configuration.

Still further in accordance with an embodiment of the present disclosure, the MZM is configured to operate with a drive voltage swing of approximately 2 volts.

Additionally in accordance with an embodiment of the present disclosure, the MZM is configured to provide an extinction ratio of at least 3 dB.

Moreover in accordance with an embodiment of the present disclosure, the MZM is configured to operate with an insertion loss of less than 6 dB.

Further in accordance with an embodiment of the present disclosure, the off-quadrature bias point corresponds to a phase difference between the first waveguide arm and the second waveguide arm that is less than 90 degrees.

There is also provided in accordance with another embodiment of the present disclosure, an optical transmitter comprising a coherent light source configured to output light comprising a plurality of wavelengths, a wavelength demultiplexer optically coupled to the coherent light source and configured to separate the light into a plurality of optical signals, each optical signal of the plurality of optical signals corresponding to a respective wavelength of the plurality of wavelengths, a plurality of Mach-Zehnder modulators (MZMs), each MZM of the plurality of MZMs configured to receive and modulate a respective optical signal of the plurality of optical signals, and a wavelength multiplexer configured to combine the modulated optical signals from the plurality of MZMs into a combined output signal.

Further in accordance with an embodiment of the present disclosure, the wavelength demultiplexer comprises Coupled Ring Resonators (CRRs).

Still further in accordance with an embodiment of the present disclosure, the wavelength multiplexer comprises CRRs.

Additionally in accordance with an embodiment of the present disclosure, at least one of the wavelength demultiplexer or the wavelength multiplexer is tunable.

Moreover in accordance with an embodiment of the present disclosure, at least one of the wavelength demultiplexer or the wavelength multiplexer is thermally tunable.

Further in accordance with an embodiment of the present disclosure, the plurality of wavelengths comprises eight wavelengths.

Still further in accordance with an embodiment of the present disclosure, the plurality of wavelengths comprises sixteen wavelengths.

Additionally in accordance with an embodiment of the present disclosure, each MZM of the plurality of MZMs is configured to modulate the respective optical signal using a non-return-to-zero (NRZ) modulation format.

Moreover in accordance with an embodiment of the present disclosure, the optical transmitter further comprises a plurality of drivers, each driver of the plurality of drivers electrically coupled to a respective MZM of the plurality of MZMs.

Further in accordance with an embodiment of the present disclosure, each MZM of the plurality of MZMs is biased at an off-quadrature operating point.

Still further in accordance with an embodiment of the present disclosure, the coherent light source comprises a multi-wavelength laser.

There is also provided in accordance with still another embodiment of the present disclosure, an optical device comprising a first Mach-Zehnder modulator (MZM) oriented in a first direction, a second MZM oriented in a second direction opposite to the first direction, the second MZM arranged parallel and adjacent to the first MZM, a first driver electrically coupled to the first MZM, and a second driver electrically coupled to the second MZM. The first driver and the second driver are disposed beneath the first MZM and the second MZM.

Further in accordance with an embodiment of the present disclosure, the optical device further comprises a plurality of additional MZMs arranged parallel and adjacent to the first MZM and the second MZM, with adjacent MZMs oriented in alternating directions.

Still further in accordance with an embodiment of the present disclosure, the optical device further comprises a plurality of additional drivers, each additional driver electrically coupled to a respective additional MZM of the plurality of additional MZMs.

Additionally in accordance with an embodiment of the present disclosure, the first MZM and the second MZM are arranged at a pitch of approximately 100 micrometers.

Moreover in accordance with an embodiment of the present disclosure, each of the first MZM and the second MZM comprises waveguide arms having a length between 1.0 millimeters and 1.2 millimeters.

Further in accordance with an embodiment of the present disclosure, each of the first driver and the second driver has a width that is greater than a pitch between the first MZM and the second MZM.

Still further in accordance with an embodiment of the present disclosure, each of the first driver and the second driver has dimensions of approximately 200 micrometers by 600 micrometers.

Additionally in accordance with an embodiment of the present disclosure, the first driver is electrically coupled to the first MZM from a first side, and the second driver is electrically coupled to the second MZM from a second side opposite to the first side.

Moreover in accordance with an embodiment of the present disclosure, the first MZM and the second MZM are disposed on a photonic integrated circuit (PIC) and the first driver and the second driver are disposed on an electronic integrated circuit (EIC).

Further in accordance with an embodiment of the present disclosure, the PIC is stacked on the EIC.

There is also provided in accordance with still another embodiment of the present disclosure, an optical module comprising a photonic integrated circuit (PIC) comprising a plurality of Mach-Zehnder modulators (MZMs), with adjacent MZMs of the plurality of MZMs oriented in alternating directions, and an electronic integrated circuit (EIC) comprising a plurality of drivers, each driver of the plurality of drivers electrically coupled to a respective MZM of the plurality of MZMs. The PIC and the EIC are arranged in a stacked configuration in which the plurality of drivers are tiled beneath the plurality of MZMs.

Further in accordance with an embodiment of the present disclosure, the plurality of MZMs are arranged at a pitch of approximately 100 micrometers.

Still further in accordance with an embodiment of the present disclosure, each MZM of the plurality of MZMs comprises waveguide arms having a length between 1.0 millimeters and 1.2 millimeters.

Additionally in accordance with an embodiment of the present disclosure, each driver of the plurality of drivers has a width that is greater than a pitch between adjacent MZMs.

Moreover in accordance with an embodiment of the present disclosure, each driver of the plurality of drivers has dimensions of approximately 200 micrometers by 600 micrometers.

Further in accordance with an embodiment of the present disclosure, the PIC further comprises a plurality of photodetectors (PDs).

Still further in accordance with an embodiment of the present disclosure, the EIC further comprises a plurality of transimpedance amplifiers (TIAs), each TIA of the plurality of TIAs electrically coupled to a respective PD of the plurality of PDs.

Additionally in accordance with an embodiment of the present disclosure, the PIC further comprises coupled ring resonators (CRRs) configured to demultiplex a plurality of wavelengths to the plurality of PDs.

Moreover in accordance with an embodiment of the present disclosure, the PIC further comprises a wavelength demultiplexer and a wavelength multiplexer.

Further in accordance with an embodiment of the present disclosure, at least one of the wavelength demultiplexer or the wavelength multiplexer comprises Coupled Ring Resonators (CRRs).

Still further in accordance with an embodiment of the present disclosure, the optical module comprises eight transmit channels and eight receive channels.

There is also provided in accordance with still another embodiment of the present disclosure, a method of manufacturing an optical module. The method comprises providing an electronic integrated circuit (EIC) comprising a plurality of drivers, providing a photonic integrated circuit (PIC) comprising a plurality of Mach-Zehnder modulators (MZMs), with adjacent MZMs of the plurality of MZMs oriented in alternating directions, and stacking the PIC on the EIC such that the plurality of drivers are tiled beneath the plurality of MZMs, with each driver of the plurality of drivers electrically coupled to a respective MZM of the plurality of MZMs.

Further in accordance with an embodiment of the present disclosure, stacking the PIC on the EIC comprises bonding the PIC to the EIC.

Still further in accordance with an embodiment of the present disclosure, the method further comprises mounting the EIC on a substrate prior to stacking the PIC on the EIC.

Additionally in accordance with an embodiment of the present disclosure, the plurality of MZMs are arranged at a pitch of approximately 100 micrometers.

Moreover in accordance with an embodiment of the present disclosure, each driver of the plurality of drivers has a width that is greater than a pitch between adjacent MZMs.

Further in accordance with an embodiment of the present disclosure, the PIC further comprises a plurality of photodetectors (PDs), and the EIC further comprises a plurality of transimpedance amplifiers (TIAs), each TIA of the plurality of TIAs electrically coupled to a respective PD of the plurality of PDs.

Still further in accordance with an embodiment of the present disclosure, the method further comprises arranging a plurality of optical modules in a tiled array, with each optical module of the plurality of optical modules comprising a PIC stacked on an EIC.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates an optical transceiver system, in accordance with an embodiment that is described herein;

FIG. 2 is a block diagram that schematically illustrates the optical transceiver system of FIG. 1 with multiplexer and demultiplexers implemented using Coupled Ring Resonators (CRRs), in accordance with an embodiment that is described herein;

FIG. 3 is a schematic diagram that illustrates a Mach-Zehnder Modulator (MZM), in accordance with an embodiment that is described herein;

FIG. 4 is a schematic diagram that illustrates a meandering configuration of an electrode structure of the MZM of FIG. 3, in accordance with an embodiment that is described herein;

FIGS. 5A-5C are graphs that illustrate performance characteristics of MZMs of varying lengths, in accordance with embodiments that are described herein;

FIG. 6 is a plan view that schematically illustrates a pair of MZMs arranged in alternating directions, in accordance with an embodiment that is described herein;

FIG. 7A is a plan view that schematically illustrates a photonic integrated circuit portion comprising a pair of MZMs, in accordance with an embodiment that is described herein;

FIG. 7B is a plan view that schematically illustrates an electronic integrated circuit portion comprising a pair of drivers, in accordance with an embodiment that is described herein;

FIG. 7C is an exploded view that schematically illustrates the photonic integrated circuit portion of FIG. 7A and the electronic integrated circuit portion of FIG. 7B forming a stacked assembly, in accordance with an embodiment that is described herein;

FIGS. 7D and 7E are side views that schematically illustrate the stacked assembly of the photonic integrated circuit portion of FIG. 7A and the electronic integrated circuit portion of FIG. 7B, in accordance with an embodiment that is described herein;

FIG. 8A is a plan view that schematically illustrates an octal module photonic integrated circuit comprising a plurality of MZMs and a plurality of photodetector and CRR combinations, in accordance with an embodiment that is described herein;

FIG. 8B is a plan view that schematically illustrates an octal module electronic integrated circuit comprising a plurality of drivers and a plurality of transimpedance amplifiers, in accordance with an embodiment that is described herein;

FIG. 8C is an exploded view that schematically illustrates the octal module photonic integrated circuit of FIG. 8A and the octal module electronic integrated circuit of FIG. 8B forming a stacked assembly in the form of an octal module, in accordance with an embodiment that is described herein;

FIG. 9 is a plan view that schematically illustrates a tiled array of octal modules, in accordance with an embodiment that is described herein; and

FIG. 10 is a flow diagram that schematically illustrates a method for manufacturing optical modules, in accordance with an embodiment that is described herein.

### DETAILED DESCRIPTION OF EMBODIMENTS

### Overview

Embodiments that are described herein provide Mach-Zehnder modulators (MZMs) and various MZM-based optical systems, including optical transmitters and optical modules.

In some embodiments, an optical transmitter comprises a coherent light source, a wavelength demultiplexer, a plurality of MZMs, and a wavelength multiplexer. The coherent light source outputs light comprising a plurality of wavelengths. The wavelength demultiplexer separates the light into a plurality of optical signals, each optical signal corresponding to a respective wavelength. Each MZM receives and modulates a respective optical signal. The wavelength multiplexer combines the modulated optical signals into a combined output signal. In certain embodiments, the wavelength demultiplexer and the wavelength multiplexer comprise Coupled Ring Resonators (CRRs), which provide tunable wavelength filtering with wider passband and sharper roll-off compared to single ring resonators.

In certain embodiments, an MZM comprises a waveguide arrangement and an electrode structure. The waveguide arrangement comprises a first waveguide arm and a second waveguide arm arranged in parallel, wherein the first and second waveguide arms have a length of less than 2 millimeters (mm). The electrode structure is associated with the waveguide arrangement and has a differential impedance of at least 100 ohms. In certain embodiments, the electrode structure comprises a meandering configuration to increase inductance and thus impedance, for example up to 200 ohms. In some embodiments, the MZM operates at an off-quadrature bias point, which enables the reduced length while maintaining acceptable extinction ratio and insertion loss for Non-Return-to-Zero (NRZ) modulation.

In certain embodiments, an optical module comprises a Photonic Integrated Circuit (PIC) and an Electronic Integrated Circuit (EIC) arranged in a stacked configuration. The PIC comprises a plurality of MZMs, wherein adjacent MZMs are oriented in alternating directions. The PIC further comprises a plurality of photodetectors (PDs) and CRRs configured to demultiplex a plurality of wavelengths to the PDs. The EIC comprises a plurality of drivers, each driver electrically coupled to a respective MZM, and a plurality of Transimpedance Amplifiers (TIAs), each TIA electrically coupled to a respective PD. The PIC and the EIC are arranged such that the drivers are tiled beneath the MZMs. In certain embodiments, the optical module comprises eight transmit channels and eight receive channels, forming an octal module.

In contrast to conventional approaches that use Micro-Ring Modulators (MRMs) for dense optical interconnects, which require complex control due to thermal sensitivity and pattern dependency, the disclosed techniques employ MZMs with external wavelength multiplexing and demultiplexing. By operating the MZMs at an off-quadrature bias point, the disclosed techniques enable reduced MZM length while maintaining performance comparable to MRMs. The alternating MZM orientation enables efficient tiling of drivers beneath the MZMs, which in turn enables a compact stacked PIC/EIC configuration for high-density optical interconnects.

### System Description

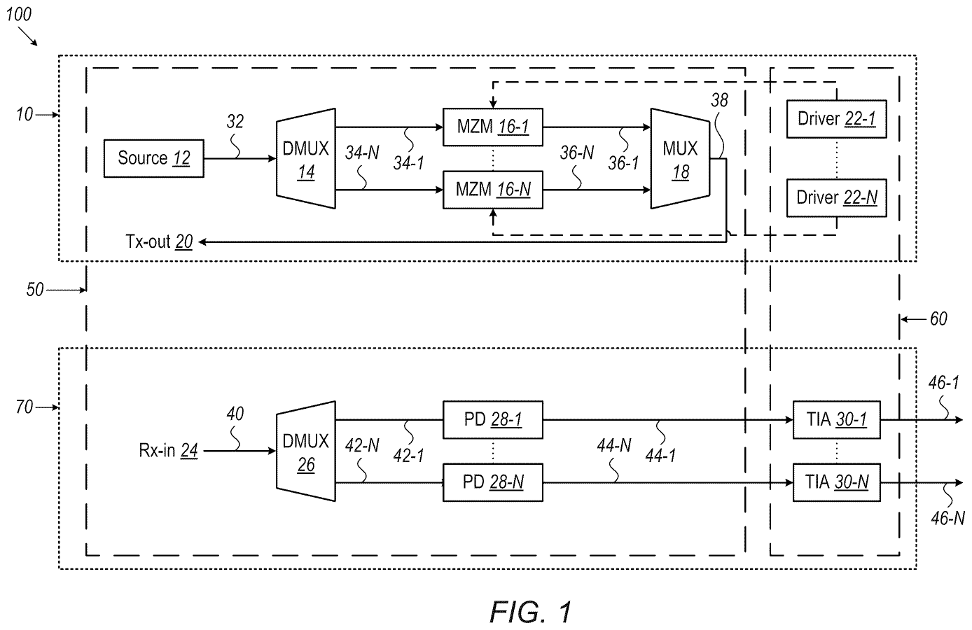

FIG. 1 is a block diagram that schematically illustrates an optical transceiver system 100, in accordance with an embodiment that is described herein. Optical transceiver system (referred to hereinafter interchangeably as “optical system”, “transceiver system”, or “system”) 100 comprises an optical transmitter (referred to hereinafter interchangeably as “transmitter”) 10 and an optical receiver (referred to hereinafter interchangeably as “receiver”) 70. Transceiver system 100 further comprises a Photonic Integrated Circuit (PIC) 50 and an Electronic Integrated Circuit (EIC) 60, each comprised of some components of transmitter 10 and receiver 70.

Transmitter 10 comprises a coherent light source 12, a wavelength demultiplexer 14, a plurality of MZMs 16-1, . . . 16-N, and a wavelength multiplexer 18. Coherent light source 12 is configured to output light 32 comprising a plurality of wavelengths. In certain embodiments, coherent light source 12 comprises a multi-wavelength laser. N is the number of wavelengths, and can be any suitable integer number. In certain embodiments, the plurality of wavelengths comprises eight wavelengths (i.e., N=8). In other embodiments, the plurality of wavelengths comprises sixteen wavelengths (i.e., N=16).

Wavelength demultiplexer 14 is optically coupled to coherent light source 12 and is configured to separate light 32 into a plurality of optical signals 34-1, . . . 34-N. Each optical signal of optical signals 34-1, . . . 34-N corresponds to a respective wavelength of the plurality of wavelengths of output light 32.

Each MZM of MZMs 16-1, . . . 16-N receives and modulates a respective optical signal of optical signals 34-1, . . . 34-N to produce modulated optical signals 36-1, . . . 36-N. In certain embodiments, each MZM modulates the respective optical signal using a Non-Return-to-Zero (NRZ) modulation format. In some embodiments, each MZM is biased at an off-quadrature operating point.

Wavelength multiplexer 18 combines modulated optical signals 36-1, . . . 36-N into a combined output signal 38. Combined output signal 38 exits optical transmitter 10 via a TX output 20.

Transmitter 10 further comprises a plurality of drivers 22-1, . . . 22-N. Each driver of drivers 22-1, . . . 22-N is electrically coupled to a respective MZM of MZMs 16-1, . . . 16-N. Each driver provides an electrical signal to drive the respective MZM. In certain embodiments, each driver provides a voltage swing of approximately 2 volts.

Receiver 70 comprises a wavelength demultiplexer 26, a plurality of PDs 28-1, . . . 28-N, and a plurality of Transimpedance Amplifiers (TIAs) 30-1, . . . 30-N. A received optical signal 40 that comprises a plurality of wavelengths (e.g., eight wavelengths, sixteen wavelengths, etc.) enters optical receiver 70 via an RX input 24. Wavelength demultiplexer 26 separates received optical signal 40 into a plurality of demultiplexed optical signals 42-1, . . . 42-N. Each optical signal of optical signals 42-1, . . . 42-N corresponds to a respective wavelength of the plurality of wavelengths of received optical signal 40.

Each PD of PDs 28-1, . . . 28-N receives a respective demultiplexed optical signal of demultiplexed optical signals 42-1, . . . 42-N and converts the optical signal to an electrical signal 44-1, . . . 44-N.

Each TIA of TIAs 30-1, . . . 30-N is electrically coupled to a respective PD of PDs 28-1, . . . 28-N. Each TIA amplifies the respective electrical signal 44-1, . . . 44-N to produce an amplified electrical signal 46-1, . . . 46-N.

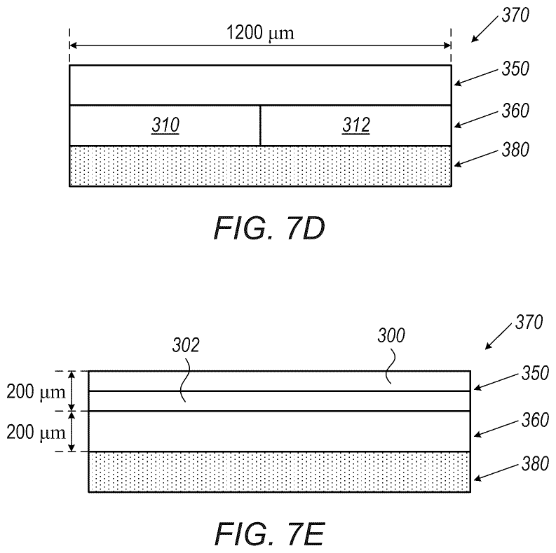

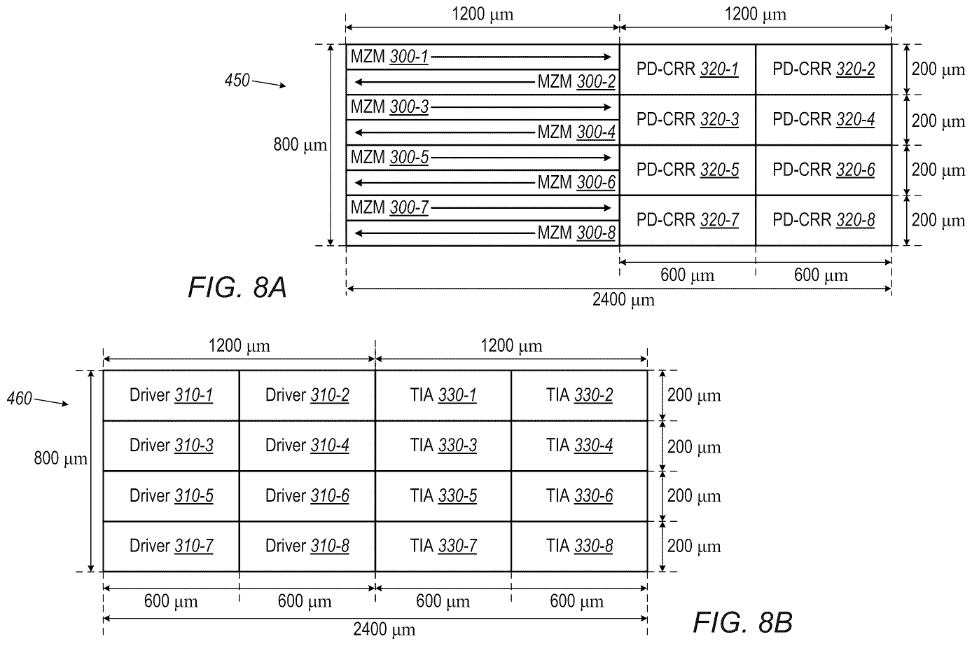

PIC 50 comprises the optical components of optical transceiver system 100, including wavelength demultiplexer 14, MZMs 16-1, . . . 16-N, wavelength multiplexer 18, wavelength demultiplexer 26, and PDs 28-1, . . . 28-N. EIC 60 comprises the electronic components of optical transceiver system 100, including drivers 22-1, . . . 22-N and TIAs 30-1, . . . 30-N. In certain embodiments, PIC 50 and EIC 60 are arranged in a stacked configuration, as will be described in further detail below with reference to FIGS. 7A-7E and FIGS. 8A-8C.

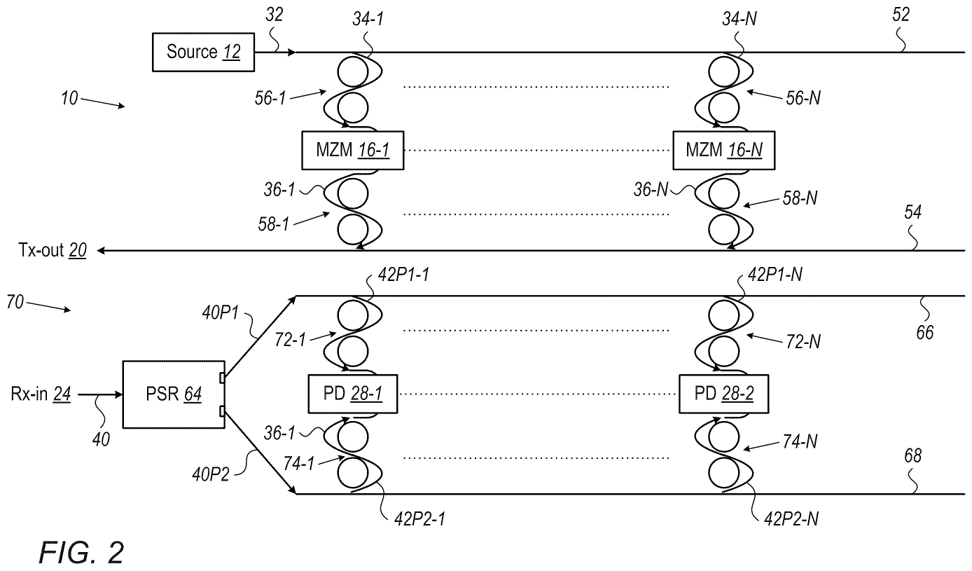

FIG. 2 is a block diagram that schematically illustrates a variation of the optical transceiver system of FIG. 1 in which the multiplexer and demultiplexers are implemented using CRRs, in accordance with an embodiment that is described herein.

On the transmitter side, coherent light source 12 outputs light 32 comprising a plurality of wavelengths onto an input waveguide bus 52. A plurality of CRRs 56-1, . . . 56-N, which collectively form wavelength demultiplexer 14 of FIG. 1, are optically coupled to input waveguide bus 52. Each CRR of CRRs 56-1, . . . 56-N is configured to drop a respective wavelength of light 32 from input waveguide bus 52 as a respective one of optical signals 34-1, . . . 34-N, and direct the respective optical signal to a corresponding MZM of MZMs 16-1, . . . 16-N.

Each MZM of MZMs 16-1, . . . 16-N receives and modulates the respective optical signal to produce a respective one of modulated optical signals 36-1, . . . 36-N. A plurality of CRRs 58-1, . . . 58-N, which collectively form wavelength multiplexer 18 of FIG. 1, are optically coupled to an output waveguide bus 54. Each CRR of CRRs 58-1, . . . 58-N is configured to couple the respective modulated optical signal from the corresponding MZM onto output waveguide bus 54. In this context, the CRR operates as an add filter, adding the modulated optical signal to the bus. The collective operation of CRRs 58-1, . . . 58-N combines modulated optical signals 36-1, . . . 36-N into combined output signal 38, which propagates along output waveguide bus 54 and exits transmitter 10 via TX output 20.

In certain embodiments, CRRs 56-1, . . . 56-N and CRRs 58-1, . . . 58-N are tunable. In some embodiments, the CRRs are thermally tunable. Thermal tunability enables adjustment of the resonant wavelength of each CRR to track variations in the wavelength of coherent light source 12, for example due to temperature drift or aging. By using tunable CRRs, transmitter 10 maintains proper wavelength alignment between coherent light source 12 and the multiplexer/demultiplexer components, thereby reducing crosstalk and optical loss.

Each CRR comprises a pair of coupled ring resonators. Compared to a single ring resonator, a CRR provides a wider passband and sharper roll-off, resulting in improved adjacent channel crosstalk performance. Each CRR introduces a small amount of optical loss. In certain embodiments, the loss per CRR is approximately 0.5 dB to 1 dB at the peak transmission wavelength. On the transmitter side, the optical signal passes through both a demultiplexing CRR and a multiplexing CRR, resulting in a combined loss of approximately 1 dB to 2 dB.

On the receiver side, received optical signal 40 enters receiver 70 via RX input 24. Received optical signal 40 passes through a Polarization Splitter Rotator (PSR) 64, which addresses polarization dependency that arises from grating couplers or other optical coupling elements. PSR 64 splits received optical signal 40 into two orthogonal polarization components and rotates one of the components so that both components are in the same polarization state. The resulting signals (designated 40P1 and 40P2) are directed onto an upper waveguide bus 66 and a lower waveguide bus 68, respectively. Each of 40P1 and 40P2 carries the same wavelength information.

A plurality of CRRs 72-1, . . . 72-N are optically coupled to upper waveguide bus 66, and a plurality of CRRs 74-1, . . . 74-N are optically coupled to lower waveguide bus 68. CRRs 72-1, . . . 72-N and CRRs 74-1, . . . 74-N collectively form wavelength demultiplexer 26 of FIG. 1. In certain embodiments, CRRs 72-1, . . . 72-N and CRRs 74-1, . . . 74-N are tunable. In some embodiments, the CRRs are thermally tunable.

Each CRR of CRRs 72-1, . . . 72-N is configured to drop a respective wavelength of 40P1 from upper waveguide bus 66 as a respective one of optical signals 42P1-1, . . . 42P1-N, and direct the respective optical signal to a corresponding PD of PDs 28-1, . . . 28-N.

Each CRR of CRRs 74-1, . . . 74-N is configured to drop a respective wavelength of 40P2 from lower waveguide bus 68 as a respective one of optical signals 42P2-1, . . . 42P2-N, and direct the respective optical signal to the corresponding PD of PDs 28-1, . . . 28-N. Each CRR of CRRs 74-1, . . . 74-N drops the same wavelength as its corresponding CRR of CRRs 72-1, . . . 72-N.

Each PD of PDs 28-1, . . . 28-N receives optical signals from both upper waveguide bus 66 (via a respective CRR of CRRs 72-1, . . . 72-N) and lower waveguide bus 68 (via a respective CRR of CRRs 74-1, . . . 74-N). This polarization diversity scheme ensures that received optical signal 40 is properly received regardless of its polarization state. Each PD combines the optical signals received from the buses 66 and 68, and converts each combined signal to an electrical signal, which can then be provided to amplifier circuitry (e.g., TIAs) as described with reference to FIG. 1.

### MZM Structure

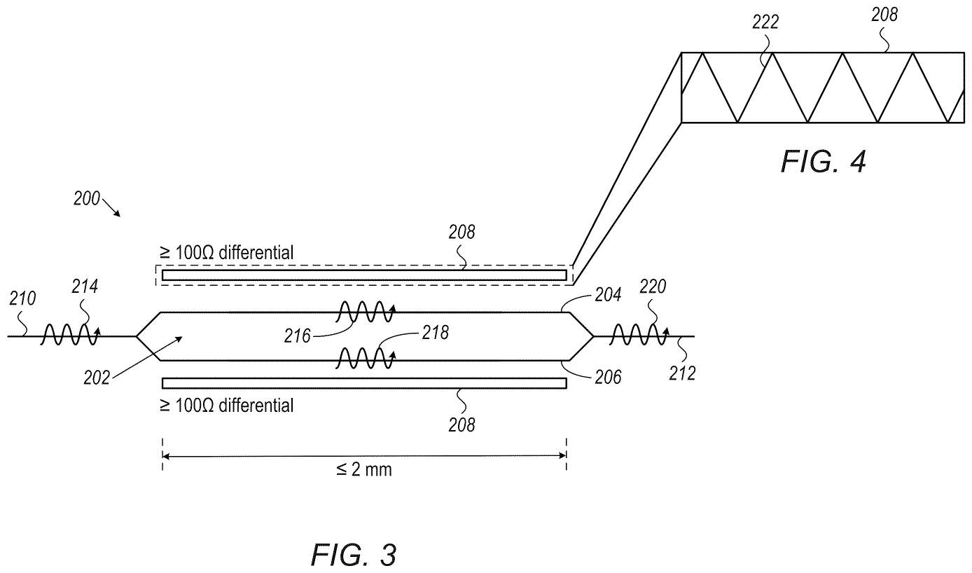

FIG. 3 is a schematic diagram that illustrates an MZM 200, in accordance with an embodiment that is described herein. In some embodiments, MZM 200 corresponds to any of MZMs 16-1, . . . 16-N of FIGS. 1 and 2.

MZM 200 comprises a waveguide arrangement 202, an electrode structure 208, an input 210, and an output 212. Waveguide arrangement 202 comprises a first waveguide arm 204 and a second waveguide arm 206 arranged in parallel (i.e., waveguide arms 204 and 206 are mutually parallel).

Input 210 receives an input optical signal 214 (which may be, for example, one of optical signal 34-1, . . . 34-N) and splits input optical signal 214 into a first optical signal portion 216 that propagates through first waveguide arm 204 and a second optical signal portion 218 that propagates through second waveguide arm 206. The propagation of the signal portions through the waveguide arms is typically through total internal reflection.

Electrode structure 208 is associated with waveguide arrangement 202 and is configured to receive an electrical signal (e.g., a drive voltage) that induces a phase shift in at least one of first optical signal portion 216 or second optical signal portion 218. The phase shift is induced via the electro-optic effect, wherein the received electrical signal changes the refractive index of the waveguide material, as is known in the art. As used herein, “associated with” refers to electrode structure 208 being positioned relative to waveguide arrangement 202 such that an electrical signal applied to electrode structure 208 induces a phase shift in light (i.e., optical signal) propagating through at least one of the waveguide arms. In certain embodiments, electrode structure 208 is disposed along both first waveguide arm 204 and second waveguide arm 206. In other embodiments, electrode structure 208 is disposed along only one of first waveguide arm 204 or second waveguide arm 206. In some embodiments, electrode structure 208 is disposed adjacent to, above, or below one or both of the waveguide arms.

Output 212 combines first optical signal portion 216 from first waveguide arm 204 and second optical signal portion 218 from second waveguide arm 206 into an output optical signal 220. Depending on the relative phase difference between first optical signal portion 216 and second optical signal portion 218, output optical signal 220 exhibits constructive or destructive interference, thereby encoding data onto the optical signal.

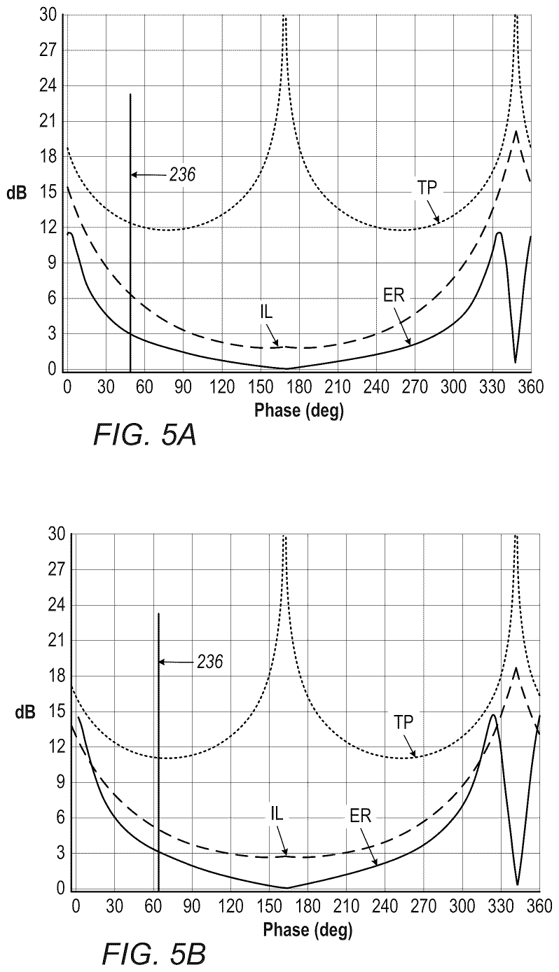

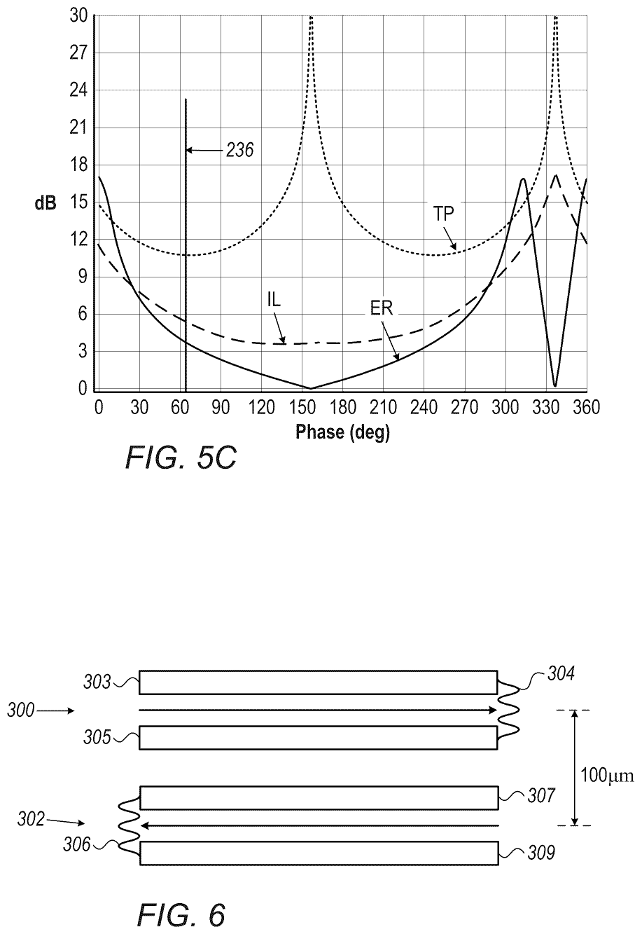

At this stage of the description, it will be pointed out that the structural and operational parameters of MZM 200 are interdependent. In particular, the length of waveguide arms 204 and 206, the differential impedance of electrode structure 208, the bias point of the MZM, and the drive voltage swing with which the MZM is configured to operate, are selected in combination to achieve target performance metrics (e.g., extinction ratio, insertion loss, bandwidth) while enabling a compact form factor suitable for dense optical interconnects. These interdependencies are described in further detail below with reference to FIG. 3, FIG. 4 and FIGS. 5A-5C.

In certain embodiments, first waveguide arm 204 and second waveguide arm 206 have a length of less than 2 mm. In some embodiments, first waveguide arm 204 and second waveguide arm 206 have a length between 1.0 mm and 1.2 mm. This is shorter than conventional MZMs, which typically have waveguide lengths of 2-3 mm.

In some embodiments, electrode structure 208 has a differential impedance of at least 100 ohms. In certain embodiments, electrode structure 208 has a differential impedance between 150 ohms and 200 ohms. Higher impedance reduces driver power consumption. Conventional MZMs with straight electrode configurations and longer waveguide lengths (e.g., 2-3 mm) typically achieve a differential impedance of approximately 65 ohms. The higher differential impedance of electrode structure 208 can be achieved via a meandering configuration, as will be described below with reference to FIG. 4.

In certain embodiments, MZM 200 is configured to operate with a drive voltage swing of approximately 2 volts.

In some embodiments, MZM 200 is biased at an off-quadrature operating point. Off-quadrature biasing enables MZM 200 to achieve a target extinction ratio (e.g., at least 3 dB) with a shorter waveguide length compared to quadrature biasing. In some embodiments, the off-quadrature operating point corresponds to a phase difference between first waveguide arm 204 and second waveguide arm 206 that is less than 90 degrees. The shortened waveguide length enabled by off-quadrature biasing, combined with the meandering electrode configuration that achieves higher impedance, enables MZM 200 to achieve performance comparable to conventional longer MZMs while providing a compact form factor suitable for dense optical interconnects.

In certain embodiments, MZM 200 is configured to operate with an insertion loss of less than 6 dB.

In some embodiments, MZM 200 is configured to modulate input optical signal 214 using a Non-Return-to-Zero (NRZ) modulation format. NRZ modulation is a two-level modulation format in which nonlinearity in the transfer function does not significantly impact performance. This enables operation at the off-quadrature bias point, which would otherwise introduce distortion for multi-level modulation formats such as PAM-4.

FIG. 4 is a schematic diagram that illustrates a meandering configuration 222 of electrode structure 208 of MZM 200, in accordance with an embodiment that is described herein. As used herein, “meandering configuration” refers to an electrode configuration having a non-linear path that increases the effective path length of electrode structure 208. A meandering configuration includes, for example, zigzag patterns, serpentine patterns, folded patterns, or other configurations that wind back and forth along the length of waveguide arrangement 202.

Meandering configuration 222 increases the inductance of electrode structure 208 by virtue of the increased effective path length. Impedance is proportional to the square root of inductance over capacitance. By increasing the inductance via meandering configuration 222, electrode structure 208 achieves a higher differential impedance (e.g., at least 100 ohms, or between 150 ohms and 200 ohms) compared to a conventional straight electrode configuration. By shortening the waveguide length to less than 2 mm (e.g., 1.0-1.2 mm) and employing meandering configuration 222, electrode structure 208 achieves a differential impedance that would not be achievable with a straight electrode configuration at the shortened length.

Higher impedance reduces driver power consumption. However, there is a trade-off with bandwidth. The group velocity of the traveling wave along electrode structure 208 is proportional to the square root of the product of the inductance and capacitance. Increasing the inductance via meandering configuration 222 increases the group index, which slows the group velocity of the electrical signal. If the inductance is increased too much, the group velocity of the electrical signal becomes mismatched with the velocity of the optical signal propagating through waveguide arrangement 202. This velocity mismatch limits the bandwidth of MZM 200. In certain embodiments, the meandering configuration 222 is designed to achieve a differential impedance of up to 200 ohms while maintaining a bandwidth of at least 23-25 GHz. The geometry of meandering configuration 222 (e.g., the number of meanders, the length of each meander segment, and the spacing between segments) is selected to balance the inductance increase with velocity matching, thereby achieving both the target impedance and the target bandwidth. A bandwidth of at least 23-25 GHz enables MZM 200 to support data rates of approximately 50 Gbps using NRZ modulation, which is suitable for dense optical interconnect applications as described herein.

FIGS. 5A-5C are graphs that illustrate performance characteristics of MZMs of varying lengths, in accordance with embodiments that are described herein. FIG. 5A illustrates performance characteristics of an MZM having a waveguide length of 1.0 mm. FIG. 5B illustrates performance characteristics of an MZM having a waveguide length of 1.5 mm. FIG. 5C illustrates performance characteristics of an MZM having a waveguide length of 2.0 mm. In each of FIGS. 5A-5C, the MZM is configured to operate with a drive voltage swing of 2 Vpp (volts peak-to-peak).

Each graph plots extinction ratio (ER), insertion loss (IL), and transmission penalty (TP) as a function of phase, which corresponds to the bias point of the MZM. The phase represents the phase difference between the first waveguide arm and the second waveguide arm (e.g., waveguide arms 204 and 206 of MZM 200). A phase of 90 degrees corresponds to the quadrature bias point, which is the conventional operating point for MZMs where linearity is maximized.

An off-quadrature operating point indicator 236 is indicated in each of FIGS. 5A-5C by a vertical line that crosses the x-axis (phase). Indicator 236 marks the phase at which the MZM achieves an extinction ratio of 3 dB. Indicator 236 corresponds to a phase of less than 90 degrees, where the MZM achieves the target extinction ratio (in this case 3 dB) at the expense of increased insertion loss compared to the quadrature bias point.

Referring to FIG. 5A, at the off-quadrature operating point indicated by indicator 236 (corresponding to a phase of approximately 50°), the 1.0 mm MZM achieves an extinction ratio of approximately 3 dB with an insertion loss of approximately 6 dB. Referring to FIG. 5B, at the off-quadrature operating point indicated by indicator 236 (corresponding to a phase of approximately 65°), the 1.5 mm MZM achieves an extinction ratio of approximately 3 dB with a lower insertion loss compared to the 1.0 mm MZM. Referring to FIG. 5C, at the off-quadrature operating point indicated by indicator 236 (corresponding to a phase of approximately 80°), the 2.0 mm MZM achieves an extinction ratio of approximately 3 dB with a still lower insertion loss.

The graphs illustrate the trade-off between waveguide length and insertion loss at a given extinction ratio. A shorter MZM (e.g., 1.0-1.2 mm) operated at an off-quadrature bias point achieves comparable extinction ratio to a longer MZM, but with higher insertion loss. However, the insertion loss of the shorter MZM (e.g., less than 6 dB for a 1.0 mm MZM) remains within acceptable limits for dense optical interconnect applications.

Notably, the performance of the 1.0 mm MZM at the off-quadrature operating point indicated by indicator 236 is comparable to the performance of a Micro-Ring Modulator (MRM). For example, an MRM operating at 1.5 V swing typically achieves an extinction ratio of approximately 3 dB with an insertion loss of approximately 5.5 dB. The 1.0 mm MZM achieves similar performance (ER of approximately 3 dB, IL of approximately 6 dB) while providing the stability and control advantages of MZM technology over MRM technology, as described above in the Background section.

The interdependencies described above with reference to FIGS. 3 and 4 are thus illustrated by FIGS. 5A-5C. By selecting an off-quadrature bias point, the waveguide length can be reduced (e.g., to 1.0-1.2 mm) while maintaining acceptable performance metrics. The reduced waveguide length, combined with the meandering electrode configuration described with reference to FIG. 4, enables a compact MZM with high impedance, low power consumption, and performance suitable for dense optical interconnect applications.

### Alternating MZM Direction

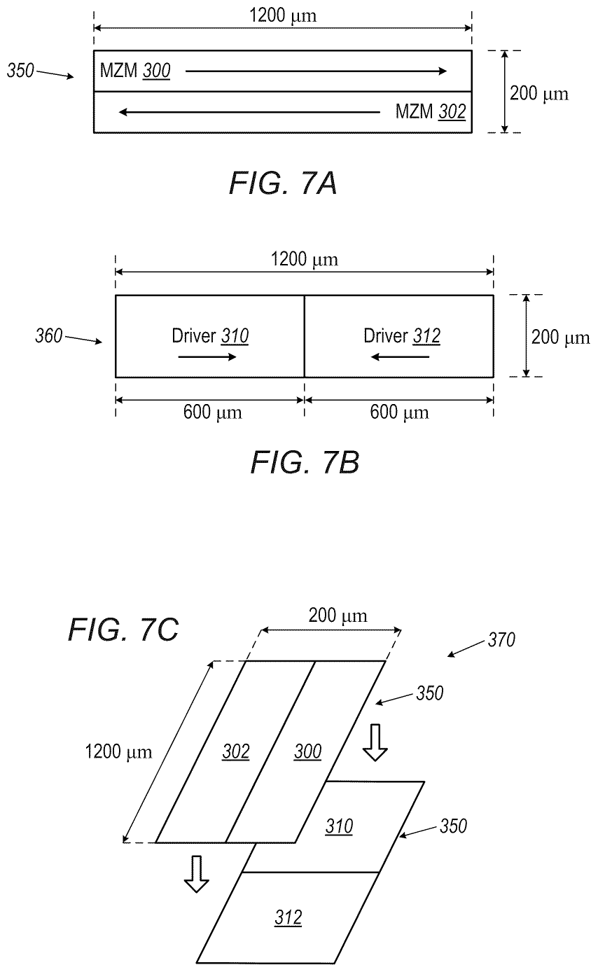

FIG. 6 is a plan view that schematically illustrates a pair of MZMs arranged in alternating directions, in accordance with an embodiment that is described herein.

As illustrated, a first MZM 300 and a second MZM 302 are arranged parallel and adjacent to one another, with first MZM 300 positioned above second MZM 302 in the plan view. First MZM 300 comprises an upper waveguide arm 303, a lower waveguide arm 305, and a combiner structure 304 that connects upper waveguide arm 303 and lower waveguide arm 305 at the output of first MZM 300. First MZM 300 is oriented in a first direction (left to right), as indicated by a left-to-right arrow, with combiner structure 304 located on the right side. Second MZM 302 comprises an upper waveguide arm 307, a lower waveguide arm 309, and a combiner structure 306 that connects upper waveguide arm 307 and lower waveguide arm 309 at the output of second MZM 302. Second MZM 302 is oriented in a second direction opposite to the first direction (right to left), as indicated by right-to-left arrow, with combiner structure 306 located on the left side. The alternating direction arrangement is illustrated by combiner structures 304 and 306 being located at opposite sides of first MZM 300 and second MZM 302. First MZM 300 and second MZM 302 are vertically aligned such that their left and right edges are aligned with one another, even though light propagates in opposite directions through the two MZMs.

First MZM 300 and second MZM 302 are arranged at a pitch, which in the figure is denoted as being approximately 100 micrometers (μm). As used herein, “pitch” refers to the center-to-center spacing between adjacent MZMs. In some embodiments, first MZM 300 and second MZM 302 each correspond to MZM 200 of FIGS. 3 and 4, with waveguide arms 303 and 305 of first MZM 300 and waveguide arms 307 and 309 of second MZM 302 each having a length less than 2.0 mm, in particular embodiments a length between 1.0 mm and 1.2 mm.

The alternating direction arrangement addresses a geometric packing challenge. Drivers for MZMs are typically wider than the MZM pitch. For example, a driver may have a width of approximately 200 μm, while the MZM pitch is approximately 100 μm. If all MZMs were oriented in the same direction, the drivers could not be efficiently tiled beneath the MZMs. By orienting adjacent MZMs in opposite directions, a first driver can be electrically coupled to first MZM 300 from a first side, and a second driver can be electrically coupled to second MZM 302 from a second side opposite to the first side. This enables two drivers to be tiled beneath two MZMs, which in turn enables a stacked configuration in which a PIC comprising the MZMs is stacked on an EIC comprising the drivers, as will be described below with reference to FIGS. 7A-7E.

### PIC/EIC Stacked Assemblies

### MZM/Driver Pair Assembly

FIGS. 7A-7E are various views of PIC and EIC portions arranged separately and in a stacked assembly (also referred to as an optical module or optical device), in accordance with an embodiment that is described herein.

FIG. 7A is a plan view that schematically illustrates a PIC 350 comprising first MZM 300 and second MZM 302. As illustrated, first MZM 300 and second MZM 302 are arranged parallel and adjacent to one another, with first MZM 300 positioned above second MZM 302 in the plan view. First MZM 300 is oriented in a first direction and second MZM 302 oriented in a second direction opposite to the first direction, and first MZM 300 and second MZM 302 are vertically aligned, as described above with reference to FIG. 6. In the illustrated example, PIC 350 has dimensions of approximately 1200 μm in length (corresponding to MZM length of 1.2 mm) and 200 μm in width.

FIG. 7B is a plan view that schematically illustrates an EIC 360 comprising a pair of drivers 310 and 312. As illustrated, first driver 310 and second driver 312 are arranged side-by-side, with first driver 310 on the left and second driver 312 on the right. First driver 310 is configured to drive first MZM 300, and second driver 312 is configured to drive second MZM 302. In the illustrated example, each of first driver 310 and second driver 312 has dimensions of approximately 600 μm in length and 200 μm in width. EIC 360 has dimensions of approximately 1200 μm in length and 200 μm in width, matching the dimensions of PIC 350.

When PIC 350 and EIC 360 are arranged in a stacked configuration (to form a stacked assembly), first driver 310 is electrically coupled to first MZM 300 from a first side (e.g., the right side), and second driver 312 is electrically coupled to second MZM 302 from a second side opposite to the first side (e.g., the left side).

FIG. 7C is an exploded view that schematically illustrates aligned PIC 350 and EIC 360 prior to or during stacking to form a stacked assembly 370. As illustrated, PIC 350 is positioned above EIC 360, showing the alignment between the MZMs and the drivers. First MZM 300 aligns with first driver 310, and second MZM 302 aligns with second driver 312.

FIGS. 7D and 7E are side views that schematically illustrate stacked assembly 370 comprising PIC 350 stacked on EIC 360, which is mounted on a substrate 380. FIG. 7D shows a side view in which first driver 310 and second driver 312 are visible within EIC 360. FIG. 7E shows another side view (orthogonal to FIG. 7D) in which first MZM 300 and second MZM 302 are visible within PIC 350.

In stacked assembly 370, PIC 350 is stacked on EIC 360 such that first driver 310 and second driver 312 are disposed beneath first MZM 300 and second MZM 302. Each driver of first driver 310 and second driver 312 is electrically coupled to a respective MZM of first MZM 300 and second MZM 302. In certain embodiments, PIC 350 is bonded to EIC 360.

The stacked configuration of PIC 350 and EIC 360 is enabled by the alternating direction arrangement of first MZM 300 and second MZM 302. As described above with reference to FIG. 6, the width of each driver (approximately 200 μm) is greater than the pitch of the MZMs (approximately 100 μm). By orienting adjacent MZMs in opposite directions, two drivers can be tiled beneath two MZMs within the same footprint. This enables a compact stacked assembly 370 suitable for dense optical interconnect applications.

### Extended Multi-channel Module

FIGS. 8A-8C are various views of PIC and EIC portions 450 and 460 arranged separately and aligned to form a stacked assembly 470, in accordance with an embodiment that is described herein. Stacked assembly 470 is an extended multi-channel module, and is referred to herein as “octal module” 470, reflecting its eight transmit and eight receive channels. Octal module 470 is an extension of the stacked assembly 370 of FIGS. 7A-7E, scaled to include eight MZMs, eight drivers, eight PD-CRR combinations, and eight TIAs.

FIG. 8A is a plan view that schematically illustrates PIC 450 comprising a plurality of MZMs and a plurality of PD-CRR combinations. As illustrated, PIC 450 comprises MZMs 300-1, 300-2, . . . 300-8 arranged parallel and adjacent to one another in a vertical stack (i.e., one below the other in the plan view), with adjacent MZMs vertically aligned and oriented in alternating directions. The arrangement of MZMs 300-1, 300-2, . . . 300-8 is an extension of the MZM pair arrangement described above with reference to FIGS. 6 and 7A. MZMs 300-1, 300-2, . . . 300-8 are arranged in a first region of PIC 450 (e.g., on the left side).

PIC 450 further comprises PD-CRR combinations PD-CRR 320-1, 320-2, . . . 320-8. PD-CRRs 320-1, 320-2, . . . 320-8 are arranged in a second region of PIC 450 (e.g., on the right side) in a row and column arrangement (e.g., two columns and four rows). Each PD-CRR of PD-CRRs 320-1, 320-2, . . . 320-8 comprises a PD and associated CRRs for wavelength demultiplexing, as described above with reference to FIG. 2. In the illustrated example, PIC 450 has dimensions of approximately 2400 μm in length and 800 μmin width.

FIG. 8B is a plan view that schematically illustrates EIC 460 comprising a plurality of drivers and a plurality of TIAs. As illustrated, EIC 460 comprises drivers 310-1, 310-2, . . . 310-8 and TIAs 330-1, 330-2, . . . 330-8 arranged in a row and column form (e.g., four rows and four columns). Drivers 310-1, 310-2, . . . 310-8 are arranged in a first region of EIC 460 (e.g., on the left side), occupying a first subset of the rows and columns of EIC 460 (e.g., the first four rows and first two columns of EIC 460). TIAs 330-1, 330-2, . . . 330-8 are arranged in a second region of EIC 460 (e.g., on the right side), occupying a second subset of the rows and columns of EIC 460 (e.g., the first four rows and last two columns of EIC 460).

This arrangement corresponds to the layout of PIC 450, such that when PIC 450 is stacked on EIC 460, the drivers align beneath the MZMs and the TIAs align beneath the PD-CRRs. Each driver of drivers 310-1, 310-2, . . . 310-8 is configured to drive a respective MZM of MZMs 300-1, 300-2, . . . 300-8. Each TIA of TIAs 330-1, 330-2, . . . 330-8 is configured to amplify an electrical signal from a respective PD of PD-CRRs 320-1, 320-2, . . . 320-8. In the illustrated example, EIC 460 has dimensions of approximately 2400 μm in length and 800 μm in width, matching the dimensions of PIC 450.

In certain embodiments, each driver of drivers 310-1, 310-2, . . . 310-8 includes associated control circuitry. Similarly, each TIA of TIAs 330-1, 330-2, . . . 330-8 includes associated control circuitry. In some embodiments, if the control circuitry cannot fit within the footprint of the respective driver or TIA, the control circuitry is positioned at an edge of EIC 460.

FIG. 8C is an exploded view that schematically illustrates aligned PIC 450 and EIC 460 prior to or during stacking to form octal module 470. As illustrated, PIC 450 is positioned above EIC 460, showing the alignment between the MZMs and the drivers, and between the PD-CRRs and the TIAs. Each MZM of MZMs 300-1, 300-2, . . . 300-8 aligns with a respective driver of drivers 310-1, 310-2, . . . 310-8. Specifically, MZM 300-1 aligns with driver 310-1, MZM 300-2 aligns with driver 310-2, and so on, such that each MZM 300-k aligns with a corresponding driver 310-k (where k=1, 2, . . . 8). Each PD-CRR of PD-CRRs 320-1, 320-2, . . . 320-8 aligns with a respective TIA of TIAs 330-1, 330-2, . . . 330-8. Similarly, PD-CRR 320-1 aligns with TIA 330-1, PD-CRR 320-2 aligns with TIA 330-2, and so on, such that each PD-CRR 320-k aligns with a corresponding TIA 330-k (where k=1, 2, . . . 8).

In octal module 470, PIC 450 is stacked on EIC 460 such that drivers 310-1, 310-2, . . . 310-8 are disposed beneath MZMs 300-1, 300-2, . . . 300-8, and TIAs 330-1, 330-2, . . . 330-8 are disposed beneath PD-CRRs 320-1, 320-2, . . . 320-8. Each driver is electrically coupled to its corresponding MZM, and each TIA is electrically coupled to its corresponding PD.

Octal module 470 has dimensions corresponding to the length and width dimensions of the PIC and EIC, which in the example is approximately 2400 μm in length and 800 μm in width. In certain embodiments, PIC 450 is bonded to EIC 460 to form octal module 470.

Octal module 470 provides eight transmit channels (via MZMs 300-1, 300-2, . . . 300-8) and eight receive channels (via PD-CRRs 320-1, 320-2, . . . 320-8). In certain embodiments, each transmit channel operates at approximately 50 Gbps using NRZ modulation, providing a total transmit data rate of 400 Gbps. Similarly, each receive channel operates at approximately 50 Gbps, providing a total receive data rate of 400 Gbps.

The stacked configuration of octal module 470 is enabled by the alternating direction arrangement of MZMs 300-1, 300-2, . . . 300-8, as described above with reference to FIGS. 6 and 7A-7E. This enables a compact octal module 470 suitable for dense optical interconnect applications.

### Tiled Array

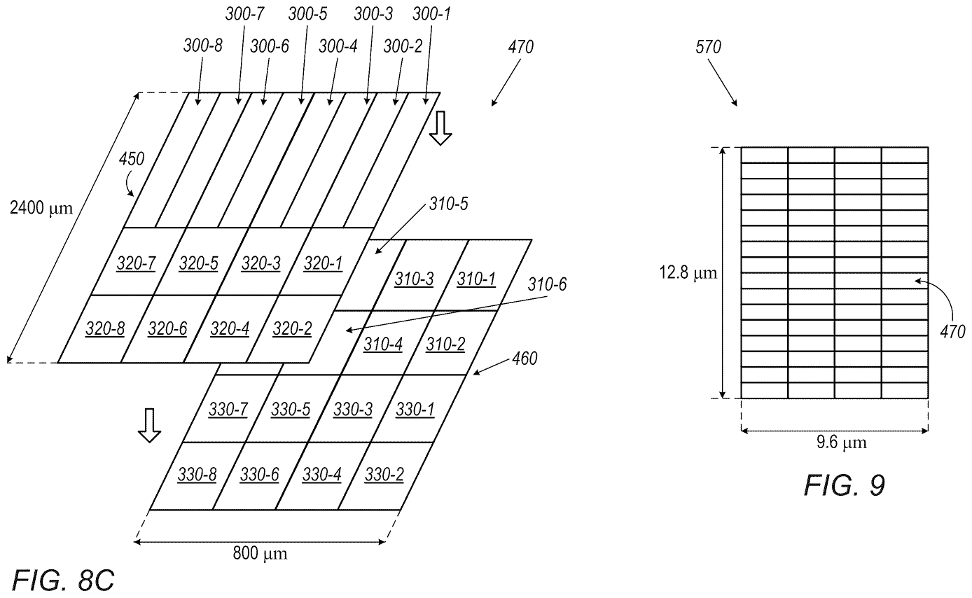

FIG. 9 is a plan view that schematically illustrates a tiled array 570 of octal modules 470, in accordance with an embodiment that is described herein. Tiled array 570 comprises a plurality of octal modules 470 arranged in a grid pattern. Each octal module 470 of tiled array 570 comprises a PIC 450 stacked on an EIC 460, as described above with reference to FIGS. 8A-8C.

In the illustrated example, tiled array 570 has dimensions of approximately 9.6 mm by 12.8 mm. Tiled array 570 comprises four columns and sixteen rows of octal modules 470, for a total of sixty-four octal modules.

Each octal module 470 provides eight transmit channels and eight receive channels, as described above with reference to FIGS. 8A-8C. With sixty-four octal modules, tiled array 570 provides a total of 512 transmit channels and 512 receive channels. At approximately 50 Gbps per channel, tiled array 570 provides a total transmit data rate of approximately 25.6 Tbps and a total receive data rate of approximately 25.6 Tbps.

In certain embodiments, tiled array 570 provides a beachfront density of approximately 4 Tbps per millimeter. Beachfront density refers to the data rate (or equivalently bandwidth) per unit length along an edge of tiled array 570, and is a key metric for dense optical interconnect applications where signals enter and exit the package along the edge.

The tiled array configuration is enabled by the compact form factor of octal module 470, which in turn is enabled by the alternating direction arrangement of MZMs and the stacked PIC/EIC configuration, as described above with reference to FIGS. 6, 7A-7E, and 8A-8C.

### Method of Manufacturing

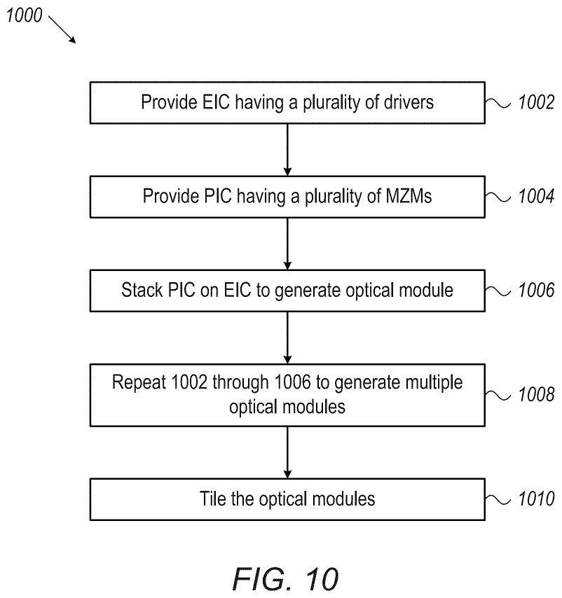

FIG. 10 is a flow diagram that schematically illustrates a method 1000 for manufacturing optical modules, in accordance with an embodiment that is described herein.

At an EIC providing stage 1002, an EIC comprising a plurality of drivers is provided. The EIC may be, for example, EIC 360 of FIGS. 7A-7E or EIC 460 of FIGS. 8A-8C.

At a PIC providing stage 1004, a PIC comprising a plurality of MZMs is provided. The PIC may be, for example, PIC 350 of FIGS. 7A-7E or PIC 450 of FIGS. 8A-8C. Adjacent MZMs of the plurality of MZMs are oriented in alternating directions, as described above with reference to FIG. 6.

At a stacking stage 1006, the PIC is stacked on the EIC such that the plurality of drivers are tiled beneath the plurality of MZMs. Each driver of the plurality of drivers is electrically coupled to a respective MZM of the plurality of MZMs. Stacking stage 1006 includes aligning the PIC and the EIC such that each MZM of the plurality of MZMs aligns with a respective driver of the plurality of drivers, as described above with reference to FIGS. 7C and 8C. In certain embodiments, the PIC is bonded to the EIC. The stacking stage 1006 generates an optical module, such as optical device 370 of FIGS. 7A-7E or octal module 470 of FIGS. 8A-8C.

At an optional repeating stage 1008, stages 1002, 1004, and 1006 are repeated to generate a plurality of optical modules. At a tiling stage 1010, the plurality of optical modules are arranged in a tiled array, such as tiled array 570 of FIG. 9.

In certain embodiments, method 1000 further comprises mounting the EIC on a substrate prior to stacking stage 1006. In certain embodiments, method 1000 further comprises bonding the PIC to the EIC during stacking stage 1006.

### Additional Considerations

As used herein, the terms “first”, “second”, and similar ordinal terms are used for identification purposes to distinguish between elements, and do not imply any particular order, sequence, preference, or priority unless explicitly stated otherwise.

As used herein, directional terms such as “left”, “right”, “above”, “below”, “upper”, “lower”, “left-to-right”, “right-to-left”, and similar terms are used for reference purposes to describe the relative positions of elements as illustrated in the figures, and are not intended to be limiting. The actual orientation of the described elements may vary depending on the implementation, and such directional terms should be interpreted accordingly.

The dimensions provided herein (e.g., 100 μm, 200 μm, 600 μm, 1200 μm, etc.) are examples and are not intended to be limiting. Other dimensions may be used depending on the specific implementation, fabrication process, and performance requirements.

Although the architectures shown and described with reference to FIGS. 7A-7E are based on a pair of MZMs and a corresponding pair of drivers, it will be understood that these architectures can be scaled up to support any suitable even number of MZMs and a corresponding number of drivers. Similarly, although the architectures shown and described with reference to FIGS. 8A-8C are based on eight MZMs, eight corresponding drivers, eight corresponding PD-CRRs, and eight corresponding TIAs, it will be understood that these architectures can be scaled up or down to support any suitable even number of MZMs and corresponding numbers of drivers, PD-CRRs, and TIAs. The use of an even number of MZMs facilitates the alternating direction arrangement described herein.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A Mach-Zehnder modulator (MZM) comprising:
a waveguide arrangement comprising a first waveguide arm and a second waveguide arm arranged in parallel, wherein the first and second waveguide arms have a length of less than 2 millimeters;
an electrode structure associated with the waveguide arrangement, the electrode structure having a differential impedance of at least 100 ohms;
an input configured to split an input optical signal into a first optical signal portion propagating through the first waveguide arm and a second optical signal portion propagating through the second waveguide arm; and
an output configured to combine the first optical signal portion from the first waveguide arm and the second optical signal portion from the second waveguide arm into an output optical signal.

2. The MZM of claim 1, wherein the MZM is configured to operate at an off-quadrature bias point.

3. The MZM of claim 1, wherein the MZM is configured to modulate the input optical signal using a non-return-to-zero (NRZ) modulation format.

4. The MZM of claim 1, wherein the first and second waveguide arms have a length between 1.0 millimeters and 1.2 millimeters.

5. The MZM of claim 1, wherein the electrode structure has a differential impedance between 150 ohms and 200 ohms.

6. The MZM of claim 1, wherein the electrode structure comprises a meandering configuration.

7. The MZM of claim 1, wherein the MZM is configured to operate with a drive voltage swing of approximately 2 volts.

8. The MZM of claim 1, wherein the MZM is configured to provide an extinction ratio of at least 3 dB.

9. The MZM of claim 1, wherein the MZM is configured to operate with an insertion loss of less than 6 dB.

10. The MZM of claim 2, wherein the off-quadrature bias point corresponds to a phase difference between the first waveguide arm and the second waveguide arm that is less than 90 degrees.

11. An optical transmitter comprising:
a coherent light source configured to output light comprising a plurality of wavelengths;
a wavelength demultiplexer optically coupled to the coherent light source and configured to separate the light into a plurality of optical signals, each optical signal of the plurality of optical signals corresponding to a respective wavelength of the plurality of wavelengths;
a plurality of Mach-Zehnder modulators (MZMs), each MZM of the plurality of MZMs configured to receive and modulate a respective optical signal of the plurality of optical signals; and
a wavelength multiplexer configured to combine the modulated optical signals from the plurality of MZMs into a combined output signal.

12. The optical transmitter of claim 11, wherein the wavelength demultiplexer comprises Coupled Ring Resonators (CRRs).

13. The optical transmitter of claim 11, wherein the wavelength multiplexer comprises Coupled Ring Resonators (CRRs).

14. The optical transmitter of claim 11, wherein at least one of the wavelength demultiplexer or the wavelength multiplexer is tunable.

15. The optical transmitter of claim 14, wherein at least one of the wavelength demultiplexer or the wavelength multiplexer is thermally tunable.

16. The optical transmitter of claim 11, wherein the plurality of wavelengths comprises eight wavelengths.

17. The optical transmitter of claim 11, wherein the plurality of wavelengths comprises sixteen wavelengths.

18. The optical transmitter of claim 11, wherein each MZM of the plurality of MZMs is configured to modulate the respective optical signal using a non-return-to-zero (NRZ) modulation format.

19. The optical transmitter of claim 11, further comprising a plurality of drivers, each driver of the plurality of drivers electrically coupled to a respective MZM of the plurality of MZMs.

20. The optical transmitter of claim 11, wherein each MZM of the plurality of MZMs is biased at an off-quadrature operating point.

21. The optical transmitter of claim 11, wherein the coherent light source comprises a multi-wavelength laser.
